(19) United States
(12) Patent Application Publication
(10) Pub. No.: US 2005/0081361 A1
(43) Pub. Date: Apr. 21, 2005

(54) Method for forming protruded shaft of sealed case for memory device

(76) Inventor: Hideyuki Miyahara, Nagano (JP)

Correspondence Address: FLYNN THIEL BOUTELL & TANIS, P.C., 2026 RAMBLING ROAD, KALAMAZOO, MI, 49008-1699, US

(21) Appl. No.: 10/958,487

(22) Filed: Oct. 5, 2004

(30) Foreign Application Priority Data
Oct. 17, 2003 (JP) 2003-357157

(51) Int. Cl. E02D 7/02; B23P 11/00

(52) U.S. Cl. 29/522.1; 29/509; 220/4.02

(57) ABSTRACT

In a method for integrally forming a protruded shaft in the base of a sealed case for a memory device in which a storage medium is housed, a metal plate for manufacturing the base is placed on a die having a hole with an inside diameter that corresponds to an outside diameter of the protruded shaft, and a portion for forming the protruded shaft in the metal plate is positioned over the hole. The portion for forming the protruded shaft in the metal plate is pressed by a press tool from the side opposite the die, and the material of the portion for forming the protruded shaft is moved into the hole to form a hollow protrusion sealed off at a distal end. The sealed distal end in the protuberance is compression-molded from a direction opposite the press direction of the press tool by a compression tool disposed in the hole, and the protruded shaft is obtained. The protruded shaft with a large effective length that is free of cracks and ruptures can be integrally formed in the base.

### 1. FIELD OF THE INVENTION

The present invention relates to a sealed case for a memory device such as a hard disk drive or another such magnetic storage device, or a compact disk drive or another such optical storage device. More specifically, the present invention relates to a method suitable for forming a protruded shaft used to mount various internal components or to support or otherwise secure rotating members on a metallic base of the sealed case while the airtightness of the sealed case is preserved.

### 2. DESCRIPTION OF THE RELATED ART

In conventional practice, a memory device such as a hard disk drive (hereinafter referred to as HDD) has a substantially dish-shaped base 100 composed of a metal plate as shown in FIG. 11A, various components are mounted in a concavity in the base 100, and a top side is open. The top surface of the base 100 is closed off by a plate-shaped top cover 101, and the entire body is formed into a substantial card shape.

Furthermore, various mechanisms are mounted in the concavity of the base 100, such as a magnetic disk as an information storage medium, a spindle motor for supporting and rotating this magnetic disk, a plurality of magnetic heads for writing and reading the information on the magnetic disk, a head actuator 102 for movably supporting these magnetic heads relative to the magnetic disk, a voice coil motor for rotating and positioning the head actuator, a substrate unit, and the like.

The head actuator 102 is rotated between an operating position and a retracted position above the magnetic disk by an electric current supplied to the voice coil motor, and a protruded shaft 103 as a stopper pin is provided to the base 100 to restrict excessive rotation past the retracted position.

To keep the interior of the base 100 airtight in an HDD, a seal member 104 composed, for example, of rubber or the like is interposed between the base 100 and a rim portion of the top cover 101 and is sandwiched from above and below, whereby the joint between these members 100 and 101 is sealed, and dust or the like is prevented from entering the base 100 from the exterior. This is intended to prevent the occurrence of errors due to foreign matter composed of minute airborne dust particles, harmful ions, or the like adhering to the surface of the magnetic disk used as the information storage medium.

In a conventional HDD, the protruded shaft 103 is configured as shown in FIGS. 11A and 11B. Specifically, the protruded shaft 103 shown in FIG. 11A is integrally formed in the inner side of the base 100 composed of a metal plate. Specifically, the base 100 is mounted on a die (not shown) in which a hole with a specific inside diameter is formed, and a cylindrical protruded shaft 103 running through the hole is protrusionly formed from a rear surface of the base 100 by burring. Also, with the protruded shaft 103 shown in FIG. 11B, a through hole is bored in the base 100, the protruded shaft 103 composed of a separately manufactured shaft member is inserted into this through hole, and the shaft is fixed to the base 100 by crimping. A means for fixedly mounting the shaft member with screws may also be employed.

As described above, the conventional protruded shaft 103 is formed into a cylindrical shape to be inserted vertically as shown in FIG. 11A. The interior of the HDD is therefore exposed to external air. This results in drawbacks whereby errors occur due to minute dust particles, harmful ions, and other types of foreign matter entering from the exterior and adhering to the surface of the magnetic disk used as an information storage medium. In order to prevent this, means are adopted whereby a sealant 105 is inserted into the hollow space in the protruded shaft 103 to block off the interior, or sealing tape is affixed to the rear surface of the base 100 to block off the interior. However, introducing the sealant 105 has been the cause of such drawbacks as the production of harmful gas from the sealant 105, and the deterioration of the surface of the magnetic disk.

Also, the method for fixedly mounting the protruded shaft 103 to the base 100 by crimping has drawbacks in that the necessary strength cannot be obtained because the thickness of the base 100 itself decreases as the HDD is made thinner. Another example of the method for forming the protruded shaft 103 is a method wherein the through hole is bored in the base 100, and the protruded shaft 103 is fixedly mounted with screws. However, this method has drawbacks in that high costs are inevitable because of increases in the number of components and operating steps.

In view of this, the applicant has proposed a novel method for forming a protruded shaft in JP-A 2003-181550 (U.S. patent application Ser. No. 10/314,493), wherein the drawbacks of the above-described conventional protruded shaft 103 or the like can be overcome. Specifically, in the first step shown in FIG. 12A, a base 110 composed of a metal plate is positioned and mounted on the top surface of a die 112 that has a hole 112a with a specific inside diameter capable of accommodating external dimensions necessary for a protruded shaft 111. In the subsequent protruded shaft formation step shown in FIG. 12B, a press tool 113 is pressed on from one side of the base 110 mounted on the die 112, and the protruded shaft 111 with a closed-off distal end side is integrally formed on the other side.

In the press tool 113, a proximal end side is formed into a cylinder shape, and a substantially conical tapered portion 113a is formed on the distal end side. The press tool 113 is pressed on from one side of the base 110, and the material of the base 110 is moved in a depth direction in the hole 112a of the die 112 and is then stopped at a specific position, whereby the protruded shaft 111 that has an overall length L100 and is closed off at the distal end side is protrusionly formed in the hole 112a. The protruded shaft 111 thus formed has characteristics that yield the necessary mechanical strength and make it easy to obtain the mechanical precision necessary for a memory device, such as being formed with high precision in the base 110.

In the method for forming the protruded shaft described herein, the material is moved while being pulled and extended in the depth direction in the hole 112a of the die 112 by applying pressure to the press tool 113, so a tensile load is applied to the distal end side of the protruded shaft as shown by the arrow in FIG. 13A. Therefore, if an amount of pressure from the press tool cannot be managed precisely, a crack 114 will sometimes appear on the distal end side of the protruded shaft as shown in FIG. 13B. Also, the tensile load exerted by the pressure of the press tool 113 will sometimes cause a rupture 115 on the proximal end side of the protruded shaft 111. In the memory device, it is vital that the interior be kept airtight, and when the crack 114 or the rupture 115 has occurred in the protruded shaft 111, problems occur in that the memory device interior cannot be kept airtight due to the crack 114 or rupture 115.

Also, when the protruded shaft is formed by applying pressure to the press tool 113, the distal end is formed into a substantially semispherical shape, as shown in FIG. 13B, because the exterior of the distal end is in a free state. When such a distal end shape is formed, an effective length L101 of the protruded shaft 111, or, specifically, the length of the outer peripheral surface perpendicular to the base 110, must inevitably decrease. Particularly, when the overall length L100 of the protruded shaft 111 is reduced as the device becomes thinner, the mounting of various components and the support of rotating members may become inadequate because the effective length L101 inevitably decreases.

### SUMMARY OF THE INVENTION

An object of the present invention is to provide a method for forming a protruded shaft wherein a protruded shaft can be integrally formed in a base of a sealed case for a memory device without causing cracks or ruptures.

In addition to the object described above, another object of the present invention is to provide a method for forming a protruded shaft wherein a protruded shaft with a considerable effective length can be integrally formed in the base of a sealed case.

Yet another object of the present invention is to provide a sealed case for an electronic device wherein a protruded shaft is formed by the novel method of the present invention.

To achieve the above-described and other objects, the present invention provides a method for forming a protruded shaft whereby a protruded shaft is integrally formed in a base of a sealed case for a memory device in which a storage medium is housed, wherein:
a metal plate used for manufacturing the base is placed on a die having a hole with an inside diameter that corresponds to an outside diameter of the protruded shaft, and a portion for forming the protruded shaft in the metal plate is positioned over the hole;
pressure is applied to the portion for forming the protruded shaft in the metal plate by a press tool from a side opposite the die, material of the portion for forming the protruded shaft is moved into the hole, and a hollow protuberance sealed off at a distal end is formed; and
the sealed distal end in the protuberance is compression-molded from a direction opposite the pressing direction of the press tool by a compression tool disposed in the hole.

According to the method of the present invention, the protruded shaft is integrally formed in the metal plate by applying pressure to the press tool from one side of the metal plate used for manufacturing the base, and moving the material of the metal plate into the hole of the die. Also, the distal end of the protuberance for forming the protruded shaft is urged and compressed by a compression member in the direction opposite the press direction of the press tool, making it possible to prevent cracks and ruptures from being produced in the distal end of the protuberance by the tensile load acting on this portion.

Therefore, since the protruded shaft can be integrally formed in the base in an airtight state, it is possible to significantly reduce air leaks (airtight leakage) brought about by such cracks or ruptures, and an interior of the sealed case of the memory device can be kept airtight. Also, the material of the distal end portion of the protuberance moves in a radial direction due to the distal end of the protuberance for forming the protruded shaft being compressed by the compression member. Consequently, the protruded shaft with the long effective length can be integrally formed in the base.

Here, the distal end of the protuberance can be compression-molded by the compression tool simultaneously with the press molding of the protuberance.

In this case, it is preferred that the compression tool is held while allowed to move in an axial direction of the hole, that the compression tool is urged by an elastic force of an elastic member capable of contracting and expanding in the axial direction of the hole, and that the distal end of the protuberance is pressed against the compression tool and compression-molded by the elastic force.

Also, it is preferred that the elastic force of the elastic member is less than the pressing force of the press tool.

Next, in the method of the present invention, the distal end of the protuberance may be compression-molded by the compression tool after the protuberance is formed.

In this case, it is preferred that the compression tool is held while allowed to move in the axial direction of the hole, and after the protuberance is formed, the compression tool is pressed against the distal end of the protuberance with a specific urging force to compression-mold the distal end.

It is also preferred that the press tool with a tapered external peripheral surface is used to press-mold the protuberance. With this approach, a long protruded shaft can easily be formed because the material of the metal plate used for manufacturing the base can be moved smoothly into the hole of the die.

Another possible aspect of the method of the present invention is that the portion for forming the protruded shaft in the metal plate opposite the hole of the die is pressed by a preloading tool having a pressing surface that is larger than the press tool to form a concavity and to move a specific amount of the material into the hole, and a bottom surface portion of the concavity is thereafter pressed by the press tool to form the protuberance. The manufacture of the protruded shaft with a large overall length can thereby be further simplified.

The present invention also relates to a sealed case for a memory device in which a storage medium is housed, wherein a metallic base and a metallic top cover that are joined in an airtight state via a seal member are provided, a protruded shaft for fixing or supporting internal components in the memory device is integrally formed in the base, the protruded shaft is a hollow protruded shaft sealed off at a distal end for keeping an interior of the sealed case in a sealed state, and the protruded shaft is formed by the method described above.

### BRIEF DESCRIPTION OF THE DRAWINGS

FIGS. 1A and 1B are process diagrams showing the method for forming a protruded shaft according to the first embodiment of the present invention;

FIG. 2 is a perspective view showing a protruded shaft formed by the formation method of the present invention;

FIG. 3 is a cross-sectional view showing a memory device in which the protruded shaft according to the present invention is formed in the base;

FIGS. 4A through 4D are cross-sectional views showing modifications of the press tool;

FIGS. 5A through 5C are process diagrams showing the method for forming a protruded shaft according to the second embodiment of the present invention;

FIGS. 6A through 6C are process diagrams showing the method for forming a protruded shaft according to the third embodiment of the present invention;

FIG. 7 is an explanatory diagram showing a modification of the method for forming a protruded shaft according to the second embodiment of the present invention;

FIGS. 8A and 8B are cross-sectional views showing modifications of the compression member;

FIGS. 9A and 9B are process diagrams showing the method for forming a protruded shaft according to the fourth embodiment of the present invention;

FIG. 10 is a process diagram showing the method for forming a protruded shaft according to the present invention wherein the protruded shaft is formed in a multistep shape;

FIGS. 11A and 11B are a cross-sectional view showing a memory device in which a conventional protruded shaft is formed;

FIGS. 12A and 12B are process diagrams showing a conventional method for forming a protruded shaft; and

FIGS. 13A and 13B are a cross-sectional view illustrating the drawbacks of a protruded shaft formed by a conventional formation method.

### DESCRIPTION OF THE PREFERRED EMBODIMENTS

A method for forming a protruded shaft on a base of a sealed case of a memory device according to the present invention will now be described with reference to the diagrams.

(Embodiment 1)

FIG. 2 is a partial cross-sectional perspective view showing a protruded shaft 2 formed by the method for forming a protruded shaft for a memory device according to the present invention. Iron, stainless steel, aluminum, or another such material that has a strength needed for a base 1 and is suitable for plastic working can be selected for a metal plate used for manufacturing the base 1. A protruded shaft 2 for supporting or positioning mechanisms in the memory device is integrally formed in the base 1 with a specific shaft length L1 by plastic deformation at a specific location. A peak of the protruded shaft 2 is formed to be substantially flat by a formation method hereinafter described in detail to increase an effective length L2 of the protruded shaft 2, or, specifically, a length of an external peripheral surface perpendicular to the base 1.

Also, a substantially conical hollow portion 3 is formed inside the protruded shaft 2 shown in FIG. 2. This hollow portion 3 is formed by plastically deforming the material of the base 1 and moving it in a direction of the distal end to increase the axial length L1 of the protruded shaft 2. A plurality of protruded shafts 2 may be provided to the base 1 according to the intended application, such as a protruded shaft for supporting the mechanisms, a protruded shaft for positioning, and the like. Also, the hollow portion 3 is preferably formed into a conical shape when the protruded shaft 2 has a substantial columnar shape, but may also have a substantially rectangular, triangular, or other such polygonal shape.

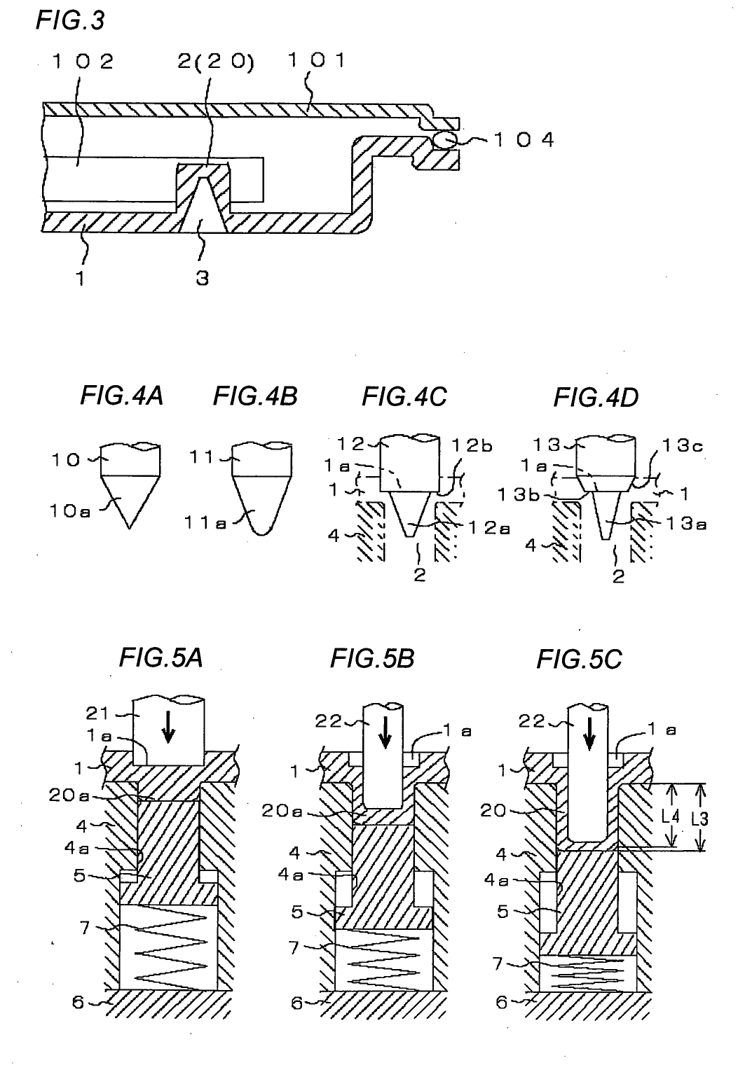

FIG. 3 shows a sealed case for the memory device in which the above-described protruded shaft 2 is formed in the base 1; for example, a sealed case for an HDD. In FIG. 3, the same symbols indicate the same elements as in FIG. 11, and explanations thereof are omitted. The protruded shaft 2 is given as an example of a stopper pin 20 in FIG. 3. Specifically, as previously described, a head actuator 102 is rotated between an operating position and a retracted position above a magnetic disk by an electric current supplied to a voice coil motor. The stopper pin 20 composed of the protruded shaft 2 is integrally formed in the base 1 to restrict this head actuator 102 in its ability to excessively rotate past the retracted position. Since the effective length L2 of the stopper pin 20 is greater than that of a conventional protruded shaft, substantially the entire width of the head actuator 102 can be brought into contact. Also, the large effective length L2 makes it possible to mount various components or support rotating members over a sufficient length.

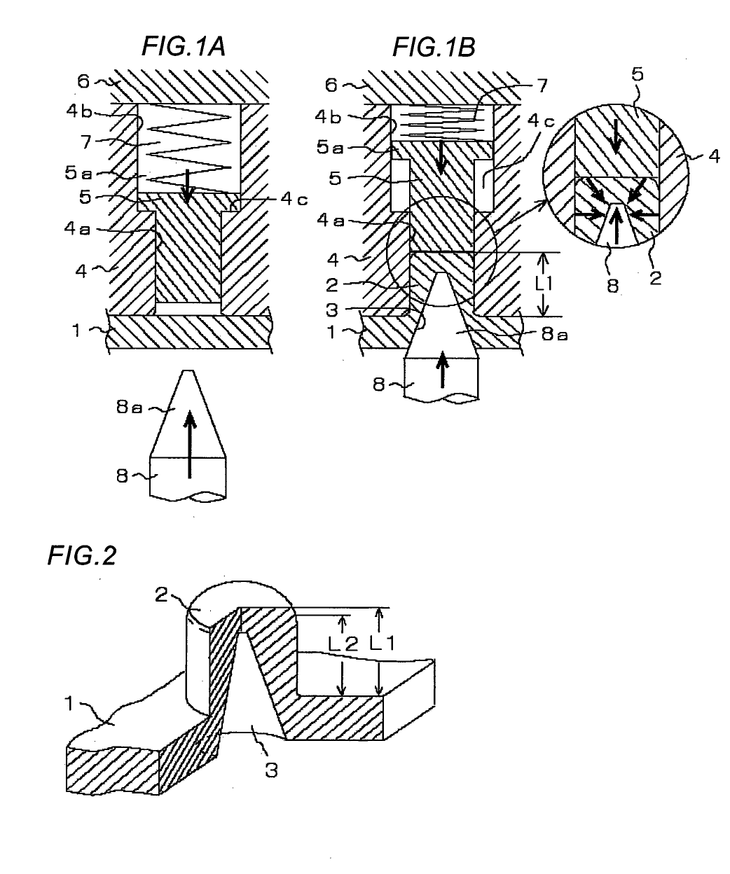

Next, the method for forming the protruded shaft for the memory device according to the present invention will be described in detail with reference to FIG. 1. FIG. 1 shows the steps of forming the protruded shaft 2. First, in the first step shown in FIG. 1A, an iron, stainless steel, aluminum, or other metal plate 1A for manufacturing the base is positioned and mounted on a top surface of a die 4.

A hole 4a with a specific inside diameter commensurate with an outer dimension needed for the protruded shaft 2 is formed in the die 4. Also, a compression member 5 is disposed on the other side of the hole 4a of the die 4. This compression member 5 is formed into a columnar shape with an outside diameter slightly smaller than the inside diameter of the hole 4a, and is designed to be capable of moving within the hole 4a in an axial direction thereof. Also, a flange 5a is formed on the other end of the compression member 5.

In this structure, a large-diameter portion 4b is formed on the other side of the hole 4a, the flange 5a moves freely within the large-diameter portion 4b in the axial direction thereof, and when the compression member 5 moves to one side of the hole 4a of the die 4, the flange 5a comes into contact with a stepped portion 4c formed in the hole 4a. Furthermore, the other side of the hole 4a of the die 4 is provided with a fixed plate 6, and an elastic member 7 composed of a coil spring is disposed between the fixed plate 6 and the other end of the compression member 5. This elastic member 7 elastically urges the compression member 5 in a direction opposite a pressing direction of a press tool 8 to be hereinafter described. An elastic force of the elastic member 7 is set to be less than the pressing force of the press tool 8.

Next, in the protruded shaft formation step shown in FIG. 1B, the protruded shaft 2 sealed off at a distal end side is integrally formed by applying pressure to the press tool 8 from one side of the metal plate 1A mounted on the die 4. The press tool 8 used in the protruded shaft formation steps is formed into a columnar shape at a proximal end side and decreases in diameter towards the distal end side, which is formed into a substantially conical tapered portion 8a with the distal end part formed into a small plane. This tapered press tool 8 is then lowered concentrically with the hole 4a in the die 4, and is pressed from one side of the metal plate 1A. The material of the metal plate 1A comes into contact with the compression member 5, is subjected to pressure, and is compressed in a direction opposite the pressing direction of the press tool 8 when the material is moved in a depth direction in the hole 4a of the die 4. In the compressed state, the press tool 8 is further lowered against the elastic force of the elastic member 7, and the material of the metal plate 1A is further moved in the depth direction in the hole 4a of the die 4. The protruded shaft 2 with the shaft length L1 and a sealed-off distal end side is formed in the hole 4a by stopping the press tool 8 just short of reaching a distal end of a protuberance 2A for the protruded shaft as illustrated, and a substantially conical hollow portion 3, with a shape similar to the tapered portion 8a of the press tool 8, is formed in the interior of the protruded shaft 2. The base 1 is then completed by removing the metal plate 1A from the die 4 and subjecting the metal plate 1A to a specific aftertreatment.

Thus, when the protruded shaft 2 is formed while elastically urging the distal end of the protuberance 2A for the protruded shaft with the compression member 5 in the direction opposite the pressing direction of the press tool 8, the material of the metal plate 1A is compressed to the side of the press tool 8 by the compression member 5, and the material at the distal end side moves in a radial direction of the hole 4a, as shown in the circle in FIG. 1. As a result, the effective length L2 shown in FIG. 2 is increased by the movement of the material in the radial direction, and the distal end of the protruded shaft 2 is formed with the same flatness as the distal end surface of the compression member 5. Also, since the distal end of the protruded shaft 2 is compressed by the compression member 5 as shown by the arrow, a tensile load created by the press tool 8 is greatly reduced, and the cracks and ruptures that had once readily occurred on the distal end side of the protruded shaft are markedly suppressed. Therefore, air leaks (airtight leakage) created by cracks or ruptures can be significantly reduced, and the memory device interior can be kept airtight. Furthermore, since the protruded shaft 2 is integrally formed in the base 1, the necessary mechanical strength and a highly precise perpendicularity are obtained, so the precision with which the mechanisms are supported or positioned is improved, and the mechanical precision needed for memory devices can be readily obtained.

The iron, stainless steel, aluminum, or other such metal plate used for the base 1 is suitable for plastic working but differs widely in ductility. It is preferable to vary a tapering angle, a shape of the distal end, or the like according to the ductility of the metal plate. When a metal plate with a comparatively low ductility is used, it is possible to use a press tool 10 wherein a distal end of a tapered portion 10a is formed into an acute angle as shown in FIG. 4A, to use the press tool 8 shown in FIG. 1 wherein the distal end surface of the tapered portion 8a is formed into a flat plane, or to use a tapered press tool 11 wherein a distal end surface of a tapered portion 11a is formed into a substantially spherical surface as shown in FIG. 4B. Also, when an even longer protruded shaft 2 is formed, it is preferable to use a press tool such as the one shown in FIGS. 4C and 4D. A press tool 12 shown in FIG. 4C has a large outside diameter in a columnar portion formed on a proximal end side, and a stepped portion 12b is formed between a substantially conical tapered portion 12a on a distal end side and the columnar portion. When the protruded shaft 2 is formed by the press tool 12 with such a shape, the amount of material needed for a long protruded shaft 2 can be increased because the material of a concavity 1a formed in the metal plate 1A is moved into the hole 4a of the die 4 by the stepped portion 12b.

Also, a press tool 13 shown in FIG. 4D forms a tapered portion 13c between a columnar portion and a stepped portion 13b. Using the press tool 13 makes it possible to smoothly move the material by lengthening a distance between the press tool 13 and an opening of the hole 4a of the die 4, and to form a protruded shaft 2 wherein cracks and ruptures are unlikely to occur. The tapered press tool need not necessarily have a rectilinear shape in the tapered portion, and the tapered portion may be formed into a substantially parabolic shape. The tapered press tool may also be formed into a polygon or another such noncircular shape.

(Embodiment 2)

FIG. 5 shows a formation method in which the shaft length is further increased in the method for forming a protruded shaft for a memory device according to the present invention. First, in the pressing step shown in FIG. 5A, iron, stainless steel, aluminum, or another such metal plate 1A for manufacturing a base is mounted on a top surface of a die 4, similar to Embodiment 1 previously described. A hole 4a with a specific inside diameter for obtaining an external dimension needed for a completed protruded shaft 20, to be hereinafter described, is formed in the die 4. Also, a compression member 5 is disposed while allowed to move in the axial direction of the hole 4a of the die 4 on the other side of the hole, similar to the example in FIG. 1. This compression member 5 is elastically urged in the direction opposite a pressing direction of a press tool 22 by an elastic member 7 composed of a coil spring disposed between a fixed plate 6 and the other end of the compression member 5. The elastic force of the elastic member 7 is set to be less than the pressing force of the press tool 22 in this embodiment as well.

Next, a flattening tool 21 with a distal end formed into a flat plane is pressed from one side of the metal plate 1A mounted on the die 4, and a concavity 1a that is shallower than a plate thickness is formed in one side of the metal plate 1A. The material of this concavity 1a is moved into the hole 4a of the die 4, and when a protrusion 20a protrudes into the hole 4a, a distal end of the compression member 5 comes into contact with the protrusion 20a, and a distal end of the protrusion 20a is compressed in the direction opposite the pressing direction of the press tool 22 by the compression member 5.

Then, in the protruded shaft formation step shown in FIGS. 5B and 5C, the columnar press tool 22 is pressed from one side of the metal plate 1A mounted on the die 4, similar to the protruded shaft formation step previously described, and the protruded shaft 20 is formed on the other side. The press tool 22 used in this protruded shaft formation step is formed into a column having substantially the same diameter from a proximal end to a distal end, and the distal end is formed into a flat plane. The press tool 22 is lowered concentrically with the hole 4a in the die 4 and brought into contact with the concavity 1a in the metal plate 1A from a state in which the distal end of the protrusion 20a is elastically urged by the compression member 5, and the protrusion 20a is then further stretched by lowering the press tool 22 against the elastic force of the elastic member 7. The protruded shaft 20 with a large shaft length L3 sealed off at the distal end side is formed in the hole 4a by lowering the press tool 22 to the position shown in FIG. 5C, and a hollow portion 24 formed by the press tool 22 is formed inside the protruded shaft 20. The metal plate 1A is then removed from the die 4.

Thus, when the distal end is elastically urged in the direction opposite the pressing direction of the press tool 22 by the compression member 5 while the flattening tool 21 is pressed to form the protrusion 20a, the material at the distal end side is compressed by the compression member 5 and moved in the radial direction of the hole 4a as in the previously described embodiment. As a result, an effective length L4 increases in this embodiment as well. Also, the tensile load created by the press tool 22 can be significantly reduced by compressing the distal end of the protruded shaft 20 with the compression member 5, cracks and ruptures can be markedly reduced, and air leaks (airtight leakage) can also be reduced significantly. Furthermore, the necessary mechanical strength is obtained due to the integration of the protruded shaft 20 and the base 1, precision is improved because a highly precise perpendicularity is obtained, and the mechanical precision needed for memory devices can be readily obtained.

When the inside diameter of the concavity 1a formed in the base 1 coincides with the external dimension of the press tool 22, the concavity 1a can be dispensed with after the protruded shaft 20 is formed by the columnar press tool 22.

(Embodiment 3)

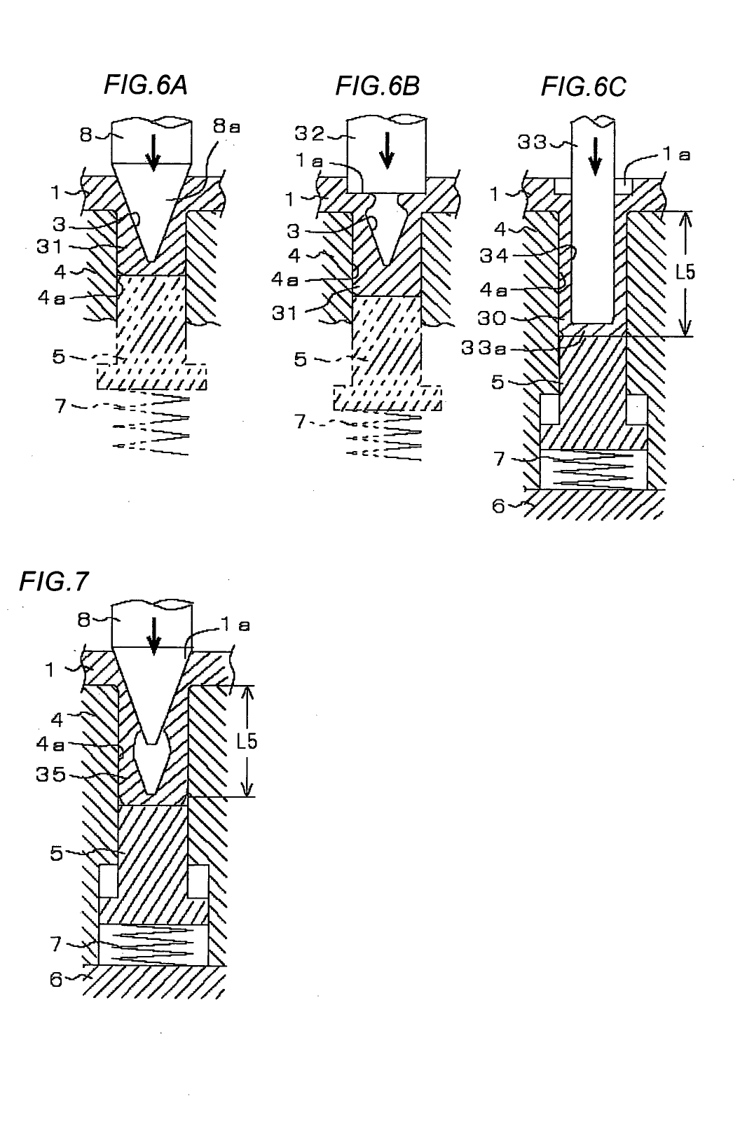

FIG. 6 shows another method in which the shaft length is further increased in the method for forming a protruded shaft for a memory device according to the present invention. First, a metal plate 1A is positioned and mounted on a top surface of a die 4 in the same manner as in the embodiments previously described, a tapered press tool 8 is then lowered concentrically with a hole 4a in the die 4 and pressed from one side of the metal plate 1A mounted on the die 4 in the same manner as in the protruded shaft formation step shown in FIG. 1A, and the material of the metal plate 1A moves in a depth direction in the hole 4a of the die 4, whereupon the material comes into contact with a compression member 5 and is compressed in a direction opposite a pressing direction of the press tool 8. The press tool 8 is further lowered against an elastic force of an elastic member 7 in this compressed state, the material of the metal plate 1A moves further in the depth direction in the hole 4a of the die 4, and a protrusion 31 is formed in the hole 4a of the die 4. As a result, a substantially conical hollow portion 3 with a similar shape as a tapered portion 8a of the press tool 8 is formed inside the protrusion 31.

A flattening tool 32 with a distal end formed into a flat plane is subsequently pressed from one side of the metal plate 1A mounted on the die 4 against the elastic force of the elastic member 7 in the same manner as in the pressing step previously described, and a concavity 1a that is shallower than a plate thickness is formed in one side of the metal plate 1A as a result of this pressure. The protrusion 31 is then stretched by the movement of the material of the concavity 1a into the hole 4a of the die 4, and the protrusion 31 with larger dimensions is formed in the hole 4a. In this stretching step, the distal end of the protrusion 31 is pressed in a direction opposite a pressing direction of the flattening tool 32 by the compression member 5, and the distal end of the protrusion 31 is compressed, as shown in FIG. 6B.

In the subsequent protruded shaft formation step shown in FIG. 6C, a columnar stretching tool 33 is lowered concentrically with the hole 4a in the die 4 from one side of the metal plate 1A mounted on the die 4 in the same manner as in the protruded shaft formation step shown in FIG. 5C, a distal end side is inserted into the hollow portion 3 from the concavity 1a formed in one side of the metal plate 1A and is pressed against the elastic force of the elastic member 7, the material that has moved into the hole 4a moves further in the depth direction in the hole 4a of the die 4, the distal end of the protrusion 31 is further stretched while being compressed by the compression member 5, and a protruded shaft 30 with a shaft length L5 that is greater than the length of the protruded shaft 20 formed by the method shown in FIG. 5 is formed in the hole 4a. The process is then completed by removing the metal plate 1A from the die 4.

As a result, a substantially columnar hollow portion 34 with nearly the same external shape as the stretching tool 33 is formed inside the protruded shaft 30. At this point, the difference between an outside diameter of the stretching tool 33 and an inside diameter of the hole 4a in the die 4 is equal to the thickness of the protruded shaft 30, and the necessary strength is obtained. Furthermore, a bottom surface 33a is formed at a distal end of the protruded shaft 30, and the distal end side is sealed off.

Since this protruded shaft 30 is formed while the distal end side is compressed by the compression member 5, cracks and ruptures are markedly reduced and air leaks (airtight leakage) can be markedly reduced as well. Furthermore, since the length of the protruded shaft 30 is further increased, the distal end portion can be appropriately modified as necessary, and the shaft can be used in a variety of applications in addition to being used to support rotating members and the like.

(Embodiment 4)

FIG. 7 is a modification of the method for forming a protruded shaft of Embodiment 2. In this modification, a tapered press tool 8 is used to form the protruded shaft instead of the columnar stretching tool 33 used in the method for forming a protruded shaft according to Embodiment 2 described above. Specifically, the modification is the same as Embodiment 2 described above in that the tapered press tool 8 is pressed against an elastic force of an elastic member 7 from one side of a metal plate 1A mounted on a die 4, a protrusion 31 is formed in a hole 4a in the die 4, a flattening tool 32 is then pressed against the elastic force of the elastic member 7 in the pressing step, and a concavity 1a is formed in one side of the metal plate 1A. In Embodiment 4 shown in FIG. 7, the press tool 8 is used again to stretch the protrusion 31 in the hole 4a from the concavity 1a formed by the pressure of the flattening tool 32. The modification is the same as Embodiment 2 in that the distal end of the protrusion 31 is pressed by a compression member 5, and the distal end of the protrusion 31 is compressed when the protrusion 31 is formed in the hole 4a of the die 4 by the pressure of the flattening tool 32, and when the protrusion 31 is stretched into the hole 4a by the press tool 8.

Since a protruded shaft 35 formed by the method for forming a protruded shaft according to Embodiment 4 described above is also formed while the distal end side is compressed by the compression member 5, an effective length L5 of the protruded shaft increases, cracks and ruptures are markedly reduced, and air leaks (airtight leakage) can be significantly reduced as well.

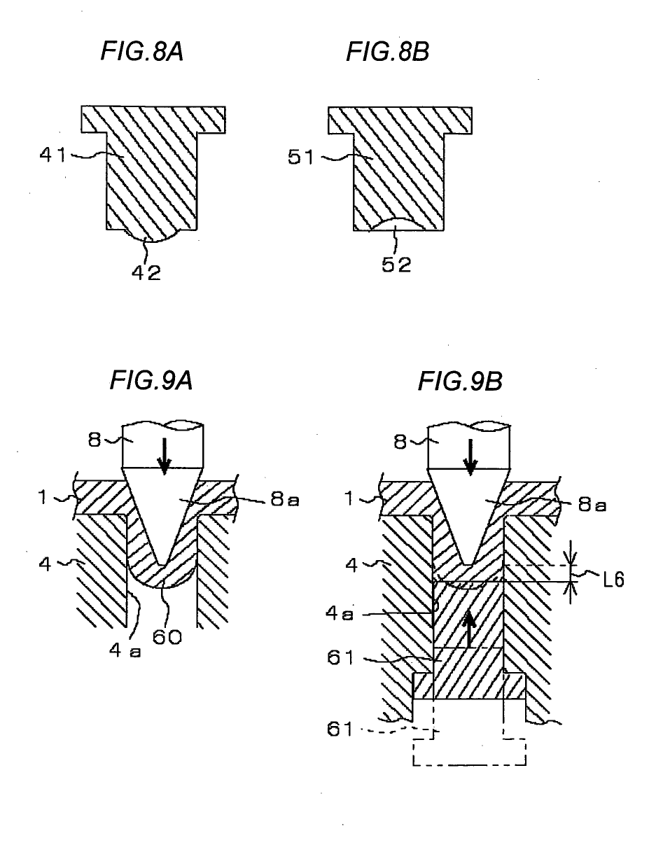

FIG. 8 shows a modification of the compression member. In the embodiments previously described, the distal end surface of the compression member is formed into the flat plane. The protruded shaft formed according to the present invention may be used as a pin for positioning, a support for rotating members, a holding member for structural components, and other such various applications. Therefore, it is necessary to modify the distal end of the protruded shaft into various shapes according to the application. A compression member 41 shown in FIG. 8A has a substantially semispherical protrusion 42 on a distal end surface. A concavity is formed in the distal end surface of the protruded shaft by using this compression member 41. Also, when the distal end of the protruded shaft is compressed by the compression member 41, the material is moved in a radial direction by a slanted surface around the protrusion 42, so an effective length of the protruded shaft can be increased. Also, a compression member 51 shown in FIG. 8B has a substantially semispherical concavity 52 in a distal end surface. A protrusion is formed on the distal end surface of the protruded shaft by using this compression member 51. The shape of the distal end surface of the compression member may be changed to a variety of shapes according to the various applications.

(Embodiment 5)

FIG. 9 shows a method in which a protruded shaft is formed and a distal end of the protruded shaft is then compressed with a compression member in the method for forming a protruded shaft for a memory device according to the present invention. In this embodiment, a protruded shaft 60 is formed by the previously described method for forming a protruded shaft shown in FIG. 1. Specifically, in the protruded shaft formation step shown in FIG. 9A, a press tool 8 is pressed from one side of a metal plate 1A mounted on a die 4, and a protrusion 60 for the protruded shaft sealed off at a distal end side is integrally formed on the other side. The distal end is formed into a substantially semispherical shape in this protruded shaft formation step because the distal end side of the protrusion 60 is in a free state.

After the protrusion 60 is thus formed, a compression member 61 is moved to a position shown by the solid line to compress the substantial semispherical distal end of the protrusion 60 as shown in FIG. 9B, with the press tool 8 in a stopped state. The distal end surface is thereby formed into a flat plane similar to the protruded shaft 2 previously described, and the protruded shaft with a large effective length L6 is obtained. When the protruded shaft is formed with the press tool 8 as described above, cracks or ruptures may sometimes occur due to a tensile load of the press tool 8 when the distal end side is in a free state. However, such cracks or ruptures can be re-closed and eliminated by compressing the distal end with the compression member 61 after the protrusion 60 has been formed.

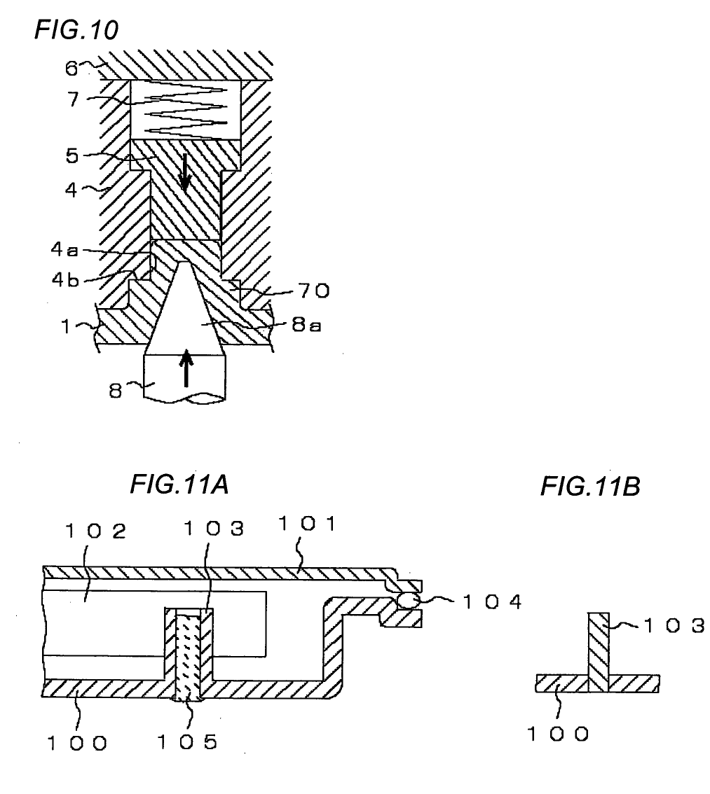

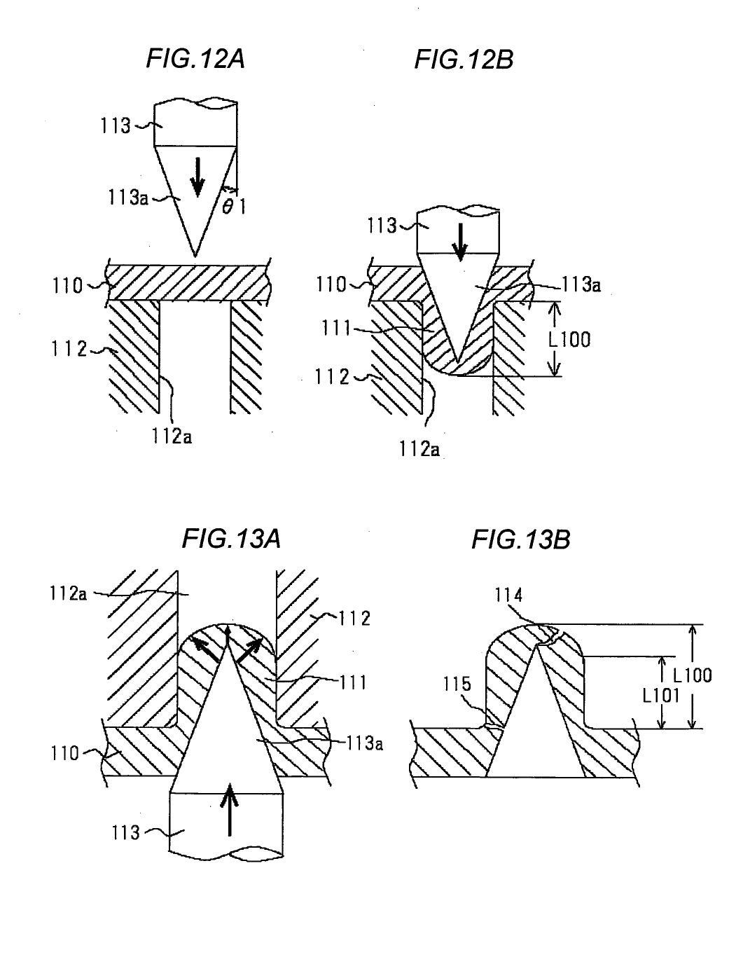

In the embodiments described above, examples were given wherein the protruded shaft was formed in a columnar shape. However, sometimes a protruded shaft with a stepped portion is needed for a base in a memory device. In this case, the protruded shaft can also be formed in a multistep shape, as shown in FIG. 10. Specifically, an opening of the hole 4a formed in the die 4 may be formed with a large diameter, and a stepped portion 4b may be formed at a position away from the hole 4a in the depth direction. The material of the metal plate 1A is moved to the stepped portion 4b perpendicular to the depth direction in the hole 4a of the die 4 by pressing the tapered press tool 8 from one side of the metal plate 1A for manufacturing the base mounted on the die 4. As a result, a stepped protruded shaft 70 is formed in the hole 4a of the die 4. This example is similar to the above-described example in that the protruded shaft 70 is formed by applying pressure to the press tool 8 while pressure is applied to the compression member 5 in the direction opposite the pressing direction of the press tool 8, whereby the material at the distal end side of the protruded shaft 70 is moved in the radial direction of the hole 4a to form the distal end surface into a flat plane and to increase the effective length.

The present invention was described in detail based on embodiments, but it is apparent that the present invention is not limited to the aforementioned embodiments and can be modified in a variety of ways within a range that does not deviate from the main points thereof. For example, the protruded shaft may be formed into a substantially rectangular or other such polygonal shape, or into an elliptical shape. Also, the hollow portion, distal end portion, or other portion of the protruded shaft may be additionally worked and arbitrarily modified according to a variety of applications. Also, in each embodiment, an example was described wherein one protruded shaft was formed in the metal plate, but two or more protruded shafts may also be formed in one base.

1. A method for forming a protruded shaft whereby a protruded shaft is integrally formed in a base of a sealed case for a memory device in which a storage medium is housed, comprising steps of:
placing a metal plate used for manufacturing the base on a die having a hole with an inside diameter that corresponds to an outside diameter of the protruded shaft, so that a portion for forming the protruded shaft in the metal plate is positioned over the hole;
pressing the portion for forming the protruded shaft in the metal plate by a press tool from a side opposite the die, so that a material of the portion for forming the protruded shaft is moved into the hole, and a hollow protuberance sealed off at its distal end is formed; and
compression-molding the sealed distal end in the protuberance from a direction opposite the pressing direction of the press tool by a compression tool disposed in the hole.

2. The method for forming a protruded shaft according to claim 1, wherein the distal end of the protuberance is compression-molded by the compression tool simultaneously with the press molding of the protuberance.

3. The method for forming a protruded shaft according to claim 2, wherein
the compression tool is held movable in an axial direction of the hole;
the compression tool is urged by an elastic force of an elastic member capable of contracting and expanding in the axial direction of the hole; and
the distal end of the protuberance is pressed against the compression tool and compression-molded by the elastic force.

4. The method for forming a protruded shaft according to claim 3, wherein the elastic force of the elastic member is less than the pressing force of the press tool.

5. The method for forming a protruded shaft according to claim 1, wherein the distal end of the protuberance is compression-molded by the compression tool after the protuberance is formed.

6. The method for forming a protruded shaft according to claim 5, wherein
the compression tool is held movable in an axial direction of the hole; and
after the protuberance is formed, the compression tool is pressed against the distal end of the protuberance with a predetermined force to compression-mold the distal end.

7. The method for forming a protruded shaft according to claim 1, wherein a press tool with a tapered external peripheral surface is used to press-mold the protuberance.

8. The method for forming a protruded shaft according to claim 1, wherein
the portion for forming the protruded shaft in the metal plate opposite the hole of the die is pressed by a preloading tool having a pressing surface that is larger than the press tool to form a concavity and to move a predetermined amount of the material into the hole; and
a bottom surface portion of the concavity is thereafter pressed by the press tool to form the protuberance.

9. A sealed case for a memory device in which a storage medium is housed, comprising:
a metallic base and a metallic top cover that are joined in an airtight state via a seal member; and
a protruded shaft for fixing or supporting internal components in the memory device that is integrally formed in the base; wherein
the protruded shaft is a hollow protruded shaft sealed off at its distal end for keeping an interior of the sealed case in a sealed state; and
the protruded shaft is formed by the method according to claim 1.
